(19) United States
(12) Patent Application Publication
(10) Pub. No.: US 2008/0109314 A1
(43) Pub. Date: May 8, 2008

(54) METHOD AND APPARATUS FOR DETERMINING A CUSTOMER'S LIKELIHOOD OF REUSING A FINANCIAL ACCOUNT

(76) Inventor: Xiao-Ming Huang, West Park (GB)

Correspondence Address: BUCKLEY, MASCHOFF & TALWALKAR LLC, 50 LOCUST AVENUE, NEW CANAAN, CT, 06840, US

(21) Appl. No.: 11/962,631

(22) Filed: Dec. 21, 2007

Related U.S. Application Data
(62) Division of application No. 10/036,048, filed on Dec. 31, 2001.

(51) Int. Cl. G06Q 30/00

(52) U.S. Cl. 705/14

(57) ABSTRACT

A system, method, apparatus, means, and computer program code for predicting or otherwise determining a customer's likelihood of reactivating or reusing a financial account, particularly when the account has a zero or near zero balance. The financial account may have a maximum loan amount, interest rate, minimum monthly payment, or other term or condition associated with it. In some embodiments, the financial account may be secured or unsecured. The customer's likelihood of reactivating the financial account may be predicted or otherwise determined by analyzing various parameters associated with the customer and/or the account. A score may be computed based on the parameters, which is indicative of the customer's likelihood of account reactivation. Once the score is computed, it may be used to select or otherwise determine one or more courses of actions (e.g., marketing activities) to take regarding the customer and/or the account.

### CROSS-REFERENCE TO RELATED INVENTION

This patent application is related to co-pending U.S. patent application entitled Method and Apparatus for Determining a Customer's Likelihood of Paying Off a Financial Account, patent application Ser. No. ______ (Attorney Docket Number G06-005), filed simultaneously herewith, the contents of which are incorporated herein by reference.

### FIELD OF THE INVENTION

The present invention relates to a method and apparatus for predicting or otherwise determining a customer's likelihood of reactivating or otherwise reusing a financial account and, more particularly, embodiments of the present invention relate to methods, means, apparatus, and computer program code for determining a course of action regarding the customer based on the customer's likelihood of reactivating or reusing the financial account.

### BACKGROUND OF THE INVENTION

In many countries, particularly those where credit cards or other bank cards are not widely used (e.g., Japan), a financial account may be established that allows a customer to obtain cash from a bank, kiosk, or other entity or device. For example, a revolving loan account may be established between an entity and a customer that allows the customer to borrow money as needed. The loan account may have a maximum loan amount, interest rate, minimum monthly payment, etc. associated with it and may be secured or unsecured. The loan account also may be a revolving account. A customer borrowing money via the loan account then makes payments towards the balance of the loan as agreed to by the customer and the entity making the loan. The customer benefits from having access to monetary amounts and the entity providing the loan earns interest on the monetary amounts borrowed by the customer.

In situations where an entity (e.g., a bank or other lender) has established many accounts, the entity may want to have as many accounts active as a time as possible. That is, the entity may want as many customers as possible to have non-zero balances in the accounts since the entity makes interest on each non-zero account. If a customer has a zero balance or a near zero balance, the entity may want to enhance its marketing and promotional efforts directed to the customer to increase the likelihood that the customer will reactivate or reuse the account by borrowing money via the account. Alternatively, the entity may want to target the customer for marketing efforts for different financial products (e.g., credit card, bank card, other financial account). As another option, the entity may want to prevent multiple, duplicate, or conflicting marketing efforts from being directed to the customer. In order to decide a course of action regarding the customer (e.g., marketing activity targeted to the customer), the entity may want to determine the likelihood that the customer having a zero or near zero balance in a loan account will reactivate the loan account.

It would be advantageous to provide a method and apparatus that assisted in predicting or otherwise determining a customer's likelihood of reusing a financial account and determining a course of action regarding the customer based on the customer's likelihood of reusing the financial account.

### SUMMARY OF THE INVENTION

Embodiments of the present invention provide a system, method, apparatus, means, and computer program code for predicting or otherwise determining a customer's likelihood of reactivating or otherwise reusing a financial account when the account has a zero or near zero balance. The financial account may have a maximum loan amount, interest rate, minimum monthly payment, or other term or condition associated with it. In some embodiments, the financial account may be secured or unsecured and/or revolving or non-revolving. The customer's likelihood of reusing the financial account may be predicted or otherwise determined by analyzing various parameters associated with the customer and/or the account. A score may be computed based on the parameters, which is indicative of the customer's likelihood of reuse of the account. Once the score is computed, it may be used to select or otherwise determine one or more courses of actions (e.g., marketing activities) to take regarding the customer and/or the account.

Additional advantages and novel features of the invention shall be set forth in part in the description that follows, and in part will become apparent to those skilled in the art upon examination of the following or may be learned by the practice of the invention.

According to embodiments of the present invention, a method for selecting a course of action regarding a customer having a zero balance for a financial account may include receiving first data associated with a customer having a financial account; receiving second data, the second data regarding the financial account; determining a score associated with the customer based, at least in part, on the first data and the second data, wherein the score is indicative of the customer's likelihood of using the financial account in the future; and selecting a course of action regarding the customer based, at least in part, on the score. In another embodiment, a method for determining if a customer is likely to reuse a loan account may include receiving data indicative of at least one parameter associated with a loan account; receiving data indicative of at least one parameter associated with a customer, wherein the customer is associated with the loan account; determining a first weighted score based on the least one parameter associated with the loan account; determining a second weighted score based on at least one parameter associated with the customer; determining a final score based on the first weighted score and the second weighted score; and comparing the final score with a threshold indicative of a likelihood that the customer will reuse the loan account. In a further embodiment, a method for determining if a customer is likely to reuse a financial account may include determining a plurality of parameters associated with a financial account and a customer associated with the loan account; determining a weighted score for each of a subset of the plurality of parameters; and determining a final score based, at least in part, on the weighted scores, wherein the final score is indicative of the customer's likelihood of using the financial account in the future.

According to embodiments of the present invention, a system for selecting a course of action regarding a customer having a financial account may include a memory; a communication port; and a processor connected to the memory and the communication port, the processor being operative to receive first data associated with a customer having a financial account; receive second data, the second data regarding the financial account; determine a score associated with the customer based, at least in part, on the first data and the second data, wherein the score is indicative of the customer's likelihood of using the financial account in the fixture; and select a course of action regarding the customer based, at least in part, on the score. In another embodiment, a system for determining if a customer is likely to reuse a loan account may include a memory; a communication port; and a processor connected to said memory and said communication port, said processor being operative to receive data indicative of at least one parameter associated with a loan account; receive data indicative of at least one parameter associated with a customer, wherein the customer is associated with the loan account; determining a first weighted score based on the least one parameter associated with the loan account; determine a second weighted score based on at least one parameter associated with the customer; determine a final score based on the first weighted score and the second weighted score; and compare the final score with a threshold indicative of a likelihood that the customer will reuse the loan account. In a further embodiment, a system for determining if a customer is likely to reuse a financial account may include a memory; a communication port; and a processor connected to the memory and the communication port, the processor being operative to determine a plurality of parameters associated with a financial account and a customer associated with the loan account; determine a weighted score for each of a subset of the plurality of parameters; and determine a final score based, at least in part, on the weighted scores, wherein the final score is indicative of the customer's likelihood of using the financial account in the future.

According to embodiments of the present invention, a computer program product in a computer readable medium for selecting a course of action regarding a customer having a financial account may include first instructions for obtaining first data associated with a customer having a financial account; second instructions for obtaining second data, the second data regarding the financial account; third instructions for associating a score with the customer based, at least in part, on the first data and the second data, wherein the score is indicative of the customer's likelihood of using the financial account in the future; and fourth instructions for determining a course of action regarding the customer based, at least in part, on the score. In another embodiment, a computer program product in a computer readable medium for determining if a customer is likely to reuse a loan account may include first instructions for obtaining data indicative of at least one parameter associated with a loan account; second instructions for obtaining data indicative of at least one parameter associated with a customer, wherein the customer is associated with the loan account; third instructions for generating a first weighted score based on the least one parameter associated with the loan account; fourth instructions for generating a second weighted score based on at least one parameter associated with the customer; fifth instructions for generating a final score based on the first weighted score and the second weighted score; and sixth instructions for making a comparison of the final score and a threshold, wherein the threshold is indicative of a likelihood that the customer will reuse the loan account. In a further embodiment, a computer program product in a computer readable medium for determining if a customer is likely to reuse a financial account may include first instructions for obtaining a plurality of parameters associated with a financial account and a customer associated with the loan account; second instructions for generating a weighted score for each of a subset of the plurality of parameters; and third instructions for generating a final score based, at least in part, on the weighted scores, wherein the final score is indicative of the customer's likelihood of using the financial account in the future.

According to embodiments of the present invention, an apparatus for determining if a customer is likely to reuse a loan account may include means for obtaining first data associated with a customer having a financial account; means for obtaining second data, the second data regarding the financial account; means for associating a score with the customer based, at least in part, on the first data and the second data, wherein the score is indicative of the customer's likelihood of using the financial account in the future; and means for determining a course of action regarding the customer based, at least in part, on the score. In another embodiment, an apparatus for selecting a course of action regarding a customer having a financial account may include means for obtaining receiving data indicative of at least one parameter associated with a loan account; means for obtaining data indicative of at least one parameter associated with a customer, wherein the customer is associated with the loan account; third instructions for generating a first weighted score based on the least one parameter associated with the loan account; means for generating a second weighted score based on at least one parameter associated with the customer; means for generating a final score based on the first weighted score and the second weighted score; and means for making a comparison of the final score and a threshold, wherein the threshold is indicative of a likelihood that the customer will reuse the loan account. In a further embodiment, an apparatus for determining if a customer is likely to reuse a financial account may include means for obtaining a plurality of parameters associated with a financial account and a customer associated with the loan account; means for generating a weighted score for each of a subset of the plurality of parameters; and means for generating a final score based, at least in part, on the weighted scores, wherein the final score is indicative of the customer's likelihood of using the financial account in the future.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a flowchart of a first embodiment of a method in accordance with the present invention;

FIG. 2 is a flowchart of a second embodiment of a method in accordance with the present invention;

FIG. 3 is a flowchart of a third embodiment of a method in accordance with the present invention;

FIG. 4 is a block diagram of system components for an embodiment of an apparatus usable with the methods of FIGS. 1-3;

FIG. 5 is a block diagram of components for an embodiment of the account manager of FIG. 4;

FIG. 6 is an illustration of a representative customer information database of FIG. 5;

FIG. 7 is an illustration of a representative account information database of FIG. 5; and

FIG. 8 is an illustration of a representative contract information database of FIG. 5.

### DETAILED DESCRIPTION

Applicants have recognized that there is a need for systems, means, computer code and methods that facilitate predicting or otherwise determining a customer's likelihood of reusing a financial account when the account has a zero or low balance.

A customer's likelihood of reusing the financial account may be predicted or otherwise determined by analyzing various variables (also referred to herein as parameters) associated with the customer and/or the account. For example, variables associated with the customer may be or include a number of people in the customer's household, the customer's job or occupation, additional sources of income associated with the customer, the customer's credit rating or history, the customer's age, the customer's income, the number of loans the customer has in effect, etc. Variables associated with an account may be or include the age of the account (usually measured in months), the average balance over a time period (e.g., six months) in the account, the number of withdrawals made from the account, the average size of withdrawals from the account, the average payment made to the account over a time period (e.g., six months), the interest rate associated with the account, the maximum loan withdrawal or balance allowed in the account, the minimum monthly payment required for the account, etc. Of course, other or different factors or variables may be taken into account in some embodiments.

Information regarding variables may be received from different sources, such as, for example, credit bureaus, loan agencies, lenders, census agencies, customers, etc. A score may be computed based on the variables, which is indicative of the customer's likelihood of account reactivation or other use. A score may be or include a numerical determination, alphabetical or other ranking, or other evaluation metric or result.

In some embodiments, once the score is computed, it may be used to select or otherwise determine one or more courses of actions (e.g., marketing or other promotional activities) to take regarding the customer and/or the account. For example, a customer who is considered likely to reuse an account may not have additional marketing efforts directed to him or her. In contrast, a customer who is not likely to reuse a loan account may have marketing efforts directed to him or her in an attempt to persuade the customer to reuse or otherwise reactivate the loan account, Alternatively, a customer who is not likely to reuse or reactivate a loan account may have marketing efforts directed to him or her in an attempt to persuade the customer establish a different financial account accept a credit card, etc. so that interest or other payments may be received from the customer via other financial products. Thus, marketing activities directed toward the customer can be coordinated or integrated more efficiently and effectively.

These and other features will be discussed in further detail below, by describing a system, individual devices, and processes according to embodiments of the invention.

Process Description

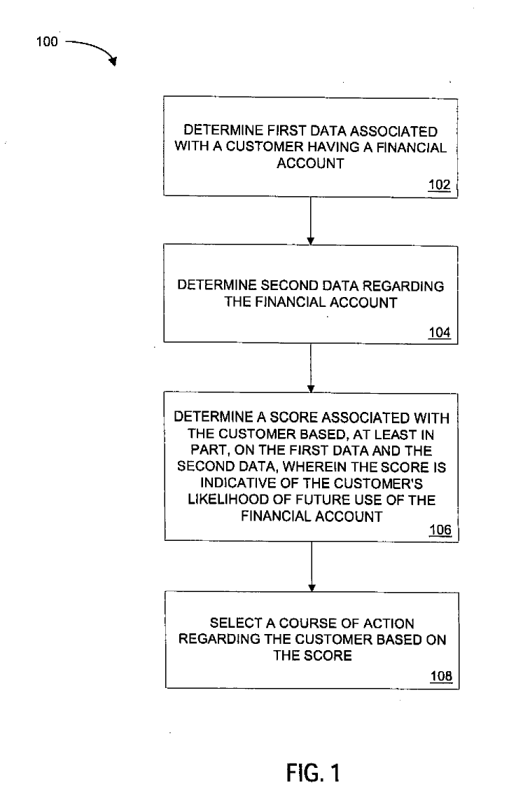

Reference is now made to FIG. 1, where a flow chart 100 is shown which represents the operation of a first embodiment of a method in accordance with the present invention. The particular arrangement of elements in the flow chart 100 is not meant to imply a fixed order to the steps; embodiments of the present invention can be practiced in any order that is practicable. In some embodiments, some or all of the steps of the method 100 may be performed or completed by a single device, such as a server, computer and/or other device, as will be discussed in more detail below.

Processing begins at a step 102 during which data is determined or otherwise received that associated with a customer having a financial account. In some embodiments, information regarding one or more customers may be stored in or accessed from a customer information database.

The data received or determined during the step 102 may be part of, or included in, an email message, instant message communication, radio transmission, facsimile transmission, Web page download, database retrieval, FTP (file transfer protocol) transmission, XML (extensible markup language) feed, HTML (Hypertext Markup Language) transmission, or other electronic signal or communication, or received via some other communication channel.

The financial account may be established via contract or other agreement between an entity (e.g., bank or other lender) and the customer. The financial account may have a maximum allowed loan amount or balance, interest rate, minimum monthly payment, minimum or maximum durations or other term or condition associated with it. In some embodiments, the financial account may be secured or unsecured. In some cases, the financial agreement also may be a revolving agreement.

In some implementations, a customer may be able to borrow money from the financial account by using a kiosk, ATM, or the monetary dispensing/receiving device. Alternatively, the customer may make withdrawals via a bank, wire transfer, etc. In addition, the customer may be able to make payments toward the account via the dispensing/receiving device or via wire transfer, bank deposit, mail-in payment, etc.

In some embodiments, the customer may need to meet at least one criterion prior to one or more steps of the method 100 being conducted. The criterion may be related to the financial account and/or the customer. For example, the criterion may require that the customer have a zero, low, or unchanged balance in the financial account, that the customer have a current balance in the financial account that is equal to or under a designated threshold amount, that the customer have an average balance over a time period (e.g., three months, six months) that is equal to or under a designated threshold amount, that the customer have a credit rating or history that at least meets one or more requirements, etc.

The data associated with the customer that is determined during the step 102 may be or include demographic information pertaining to the customer. For example, such demographic information may be or include the customer's age, income, income source, occupation, occupation type or category, marital status, household size, length of time in current job, etc. In addition, in some embodiments, the data determined during the step 102 may include information regarding one or more additional financial accounts established by or for the customer, one or more transactions involving the customer, etc. Demographic Information regarding a customer may be determined when the customer enters an agreement to establish a financial account.

In some embodiments, the data determined during the step 102 may be or include information regarding other one or more additional sources of income for the customer. For example, a customer may be entitled to, or be expected to, receive a bonus or other payment from the customer's employer. In some embodiments, an entity establishing a loan account with the customer may require or expect that the customer make some minimum payment (e.g., interest payments) to the account on a regular basis (e.g., once a month). If the customer is expected or entitled to receive a bonus from his or her employer, the entity may establish a separate loan account for the customer that is tied to the bonus. Such a loan account is referred to herein as a bonus account. For example, suppose a customer will receive a bonus twice a year from the customer's employer. The bonus account may require or expect that the customer make payments to the loan account twice a year in the months that coincide with the months that the customer is receiving the bonuses. Typically, the entity may not establish a bonus account with the customer unless the entity already has another loan account with the customer or unless the entity has some other relationship with the customer from which to judge the merits of establishing a bonus account for the customer. Bonus accounts are used in some countries such as Japan. A bonus account variable may be indicative of how many bonus accounts the customer has opened or will open in a time period. Alternatively, a bonus account variable may be indicative that the customer has bonus accounts, the total balance associated with the bonus accounts, the total available credit line associated with the bonus accounts, etc. Information regarding a bonus account associated with a customer may be determined or obtained when the customer enters an agreement to establish the bonus account. In addition, information regarding a bonus account for a customer may be obtained after the customer has opened an original financial account that is not tied to a bonus the customer expects to receive in the future.

In some embodiments, the data determined during the step 102 may be or include information regarding a credit permission category associated with the customer. A credit permission category is or represents awareness of, or agreement by, a customer's family member to the establishment of a financial account for the customer and may be used to evaluate the customer when the customer wants to enter into an agreement to establish the financial account. For example, a spouse of a customer may agree to the establishment of a financial account by the customer. The spouse may then be contacted or notified regarding the financial account if the customer is unavailable.

One or more credit permission categories or bands may be established by an entity implementing the method 100, an entity entering into an agreement with the customer to provide the loan account to the customer, a government agency, or some other entity. In some embodiments, a credit permission category associated with a customer may be or include the following:

| | |
|---|---|
| Category 1 | Confidential |
| Category 2 | Agreed by spouse |
| Category 3 | Agreed by father |
| Category 4 | Agreed by mother |
| Category 5 | Agreed by siblings |
| Category 6 | Agreed by all members of family |
| Category 7 | Agreed by parents |

For example, the credit permission category 1 of “Confidential” may mean or represent that no one other than the customer is aware of the financial account while the credit permission category 2 of “Agreed by spouse” means or represents that the customer's spouse is aware of; and may have agreed to, the financial account.

In some embodiments, the data determined during the step 102 may include information regarding a job type associated with the customer and may provide information regarding a nature of the customer's occupation. Information regarding a customer's job type may be determined when the customer enters into an agreement to establish a financial account. One or more job types may be established by a governmental agency, an entity implementing the method 100, an entity providing a financial account to a customer, etc. In some embodiments, a job type associated with a customer may be or include the following:

| | |
|---|---|
| Job Type 0 | Missing or Non Registered |
| Job Type 1 | Executive |
| Job Type 2 | Managerial |
| Job Type 3 | Shop Owner/Private Company Owner |
| Job Type 4 | Expert/Engineer |
| Job Type 5 | Administrative |
| Job Type 6 | Outside Office |
| Job Type 7 | Operator |
| Job Type 8 | Salesperson |
| Job Type 9 | Traveling Salesperson |
| Job Type 10 | Mediator |
| Job Type 11 | Route Salesperson |
| Job Type 12 | Consumer Service |
| Job Type 13 | Laborer |

In some embodiments, the data determined during the step 102 may be or include information regarding a credit history, credit rating and/or credit trend associated with the customer. In addition, in some embodiments, the data determined during the step 102 may include information regarding one or more additional loans or other financial accounts associated with one or more customers, the balances in the accounts, any delinquencies associated with the accounts, etc. This information may be provided by one or more credit bureaus, banks, lenders, etc.

In some embodiments, the data determined during the step 102 may be or include information regarding a customer's loan channel or most frequently used loan channel (i.e., the avenue by which the customer receives funds or makes a loan from the account). In some embodiments, a loan channel or most frequently used loan channel for a customer may be designated as follows:

| | |
|---|---|
| Channel Type 1 | Other |
| Channel Type 2 | Mail |
| Channel Type 3 | Bank Transfer |
| Channel Type 4 | Collection |
| Channel Type 5 | Automatic Teller Machine (ATM) |
| Channel Type 6 | Direct Debit |
| Channel Type 7 | Branch |

In some embodiments, a loan channel for a customer may be related to or the same as how the customer receives compensation or salary.

In some embodiments, the data determined during the step 102 may be or include information regarding insurance or insurance category or categories associated with the customer. An insurance category for a customer is or may represent the type of insurance the customer is covered under. Information regarding a customer's insurance or insurance category may be determined when the customer enters into an agreement to establish a financial account. The insurance or insurance categories may be established by a governmental agency, an entity implementing the method 100, an entity providing loan account to a customer, etc. and may be or include the following:

| | |
|---|---|
| Category 0 | Not registered |
| Category 1 | Social |
| Category 2 | Union |
| Category 3 | Mutual Aid |
| Category 4 | National |
| Category 5 | Construction |
| Category 6 | Seamens |
| Category 7 | Other |

For example, the category 0 of “Not registered” means or represents that the customer does not have insurance while the category 4 of “National” means or represents that the customer is provided with insurance by or from a government agency or organization and the category 2 of “Union” means or represents that the customer is provided with insurance by or from a union organization (e.g., teachers' union, electricians' union). The “Construction” and “Seamens” categories are industry groups or associations that may provide or sell insurance to members.

In some embodiments, the data determined during the step 102 may be or include information regarding one or more agreements in effect that are associated with the customer when the customer establishes a financial account or the customer enters into a new contract for an existing account. For example, the customer may be asked questions regarding insurance coverage whenever the customer establishes or changes an account. The agreement may be a revolving agreement or a non-revolving agreement.

Data received during the step 102 may be received as part of other types of data received by an entity or a device. For example, during the step 102, a device or entity implementing the step 102 may receive data regarding demographic or social information, credit information, account history information, contract information, information regarding other accounts or transactions, loan channel information, payment history information, delinquency information, for one or more customers.

Data received during the step 102 may come from one or more sources. For example, a device or entity implementing the step 102 may receive data from lenders, employers, government agencies, customers, transaction participants, census bureaus or agencies, credit bureaus, transaction participants, databases, websites, etc. Alternatively, an entity or device implementing the step 102 may develop, ascertain, generate, etc. some or all of the data itself. Different types of data may be received or otherwise determined at different times during the step 102, received via different communication channels, received from different sources, etc.

During a step 104, data is received or otherwise determined regarding the financial account associated with the customer involved in the step 102. In some embodiments, the step 104 may be initiated or completed simultaneously with the step 102, as part of the step 102, or before the step 102. Thus, in some embodiments, the steps 102 and 104 may be initiated or completed as a single step. In some embodiments, information regarding one or more financial accounts may be stored in or accessed from a financial account information database.

The data received or determined during the step 104 may be part of, or included in, an email message, instant message communication, radio transmission, facsimile transmission, Web page download, database retrieval, FTP transmission, XML feed, HTML transmission, or other electronic signal or communication or via some other communication channel.

In some embodiments, data regarding a financial account may be or include information regarding an interest rate, minimum monthly payment, maximum allowable balance, etc. associated with the account. As other examples, in some embodiments, the data determined during the step 104 may be or include information regarding the number of payments made toward the balance of a financial account during a designated time period (e.g., previous six months, previous three months), a number of loans or withdrawals made by a customer during a designated time period (e.g., previous six months, previous three months), the number of decreases or increases in a balance of a financial account during a time period or observation window (e.g., previous six months), information regarding at least one delinquent payment associated with the financial account, information regarding a number of delinquent payments made to the financial account during a time period, etc.

In some embodiments, the data determined during the step 104 may include information regarding a credit utilization ratio associated with the financial account. A credit utilization ratio for a financial account may be related to use of the account and provide an indication of level of use of the account and may be computed by dividing the customer's current account balance by the maximum allowable balance for the account. The higher the current credit utilization ratio for an account, the greater the current balance in the account. In some embodiments, the data determined during the step 104 may include information regarding a minimum of credit usage or utilization over a time period (e.g., three months).

In some embodiments, the data determined during the step 104 may include information regarding the percentage of a customer's credit line available for loan to the customer, referred to herein as the remaining credit line ratio. The higher the current remaining credit line ratio for an account, the lower the current balance in the account. As one example of how a remaining credit line ratio might be calculated, assume that a customer has a loan account that allows a maximum loan amount of ten thousand dollars ($10,000). Thus, the customer has a credit line of ten thousand dollars. The customer's remaining credit line ratio may be calculated as follows: (the credit limit of the account minus the balance of the account) divided by the credit limit of the account, or (account credit limit minus account balance)/(account credit limit). If the customer has borrowed four thousand dollars ($4,000) via the account, the customer's remaining credit line ratio is ($10,000−$4,000)/$10,000 or 0.6.

In some embodiments, the data determined during the step 104 may be or include information regarding a minimum credit utilization ratio for a financial account and a given time period. For example, a minimum credit utilization ratio for an account during a three month time period may be the minimum of multiple credit utilization ratios measured for the account over the three month time period. A credit utilization ratio may be determined for the account once per day, once per week, once per month, etc. during the three month time period. The minimum credit utilization ratio for the three month time period will be the lowest of these determined credit utilization ratios.

In some embodiments, the data determined during the step 104 may be or include information regarding a minimum remaining credit line ratio for a financial account and a given time period. For example, a minimum remaining credit line ratio for an account during a three month time period may be the minimum of multiple remaining credit line ratios measured for the account over the three month time period. A remaining credit utilization line ratio for an account may be determined for the account once per day, once per week, once per month, etc. during the three month time period. The minimum remaining credit line ratio for the three month time period will be the lowest of these determined remaining credit line ratios.

In some embodiments, the data determined during the step 104 may be or include information regarding an average balance reduction associated with the financial account. For example, an average balance reduction for a financial account may be or include information regarding the average balance reduction for the financial account over a time period (e.g., three months, six months).

In some embodiments, the data determined during the step 104 may be or include information regarding an account age associated with the financial account. An account age for a financial account may be or include the time in days, weeks, months, etc. since the account was established, contractually agreed to, first used, etc.

In some embodiments, the data determined during the step 104 may include information regarding one or more loan channels (e.g., bank draft, automatic teller machine) used to obtain a loan from a financial account.

Data received or otherwise determined during the step 104 may be received as part of other types of data received by an entity or a device. For example, during the step 104, a device or entity implementing the step 104 may receive data regarding demographic or social information, credit information, account history information, contract information, information regarding other accounts or transactions, payment history information, delinquency information, for one or more customers.

Data received or otherwise determined during the step 104 may come from one or more sources. For example, a device or entity implementing the step 104 may receive data from lenders, census bureaus or agencies, credit bureaus, transaction participants, databases, etc. Alternatively, an entity or device implementing the step 104 may develop, ascertain, generate, etc. some or all of the data itself. In some embodiments the data determined during the step 104 (and/or the step 102) may include information regarding when, where, how, etc. a customer makes payments or withdrawals regarding the account. Different types of data may be received or otherwise determined at different times during the step 104, received via different communication channels, received from different sources, etc.

During a step 106, a rating, evaluation, ranking, estimation, grade, valuation, assessment, appraisal, indicator, predictor, judgment, etc. (hereafter referred to as a “score”) is computed or otherwise determined that is associated with the customer and based, at least in part, on the data determined during the steps 102 and 104. The score may be indicative of the customer's likelihood of reactivating a financial account if the financial account has a zero balance or the customer's likelihood of reusing the financial account in the future. Furthermore, the score may be indicative of the customer's likelihood of reactivating or reusing the financial account when the customer or the account meets a designated criterion. For example, the criterion for the customer may be that the customer must have completely paid off a balance of a financial account within the previous month. Alternatively, the criterion for the customer may be that the customer has not taken a loan from the financial account during the previous six months.

A score may be or include a numerical determination or representation, category or level determination (e.g., different categories or levels indicate different likelihoods of a customer reusing a financial account), formula or metric result, requirement(s) check or assessment, model result, letter rating, etc. and be determined in accordance with an algorithm, model, heuristic, procedure, expert system, rule, etc. Thus, in some embodiments, determining a score may be or include determining a category or level a customer is in, comparing data regarding the customer and/or an account associated with the customer with different indicators or predictors of a customer's later action, using data regarding the customer and/or an account associated with the customer to create an assessment or a prediction of the customer's likelihood of reusing a financial account, etc. In some embodiments, information regarding one or more scores or scoring algorithms, models, etc. may be stored in or accessed from a score or scoring information database.

As one example of how a scoring system might be used for a financial account (assumed to be a loan account for purposes of this example), the following variables might be used to determine a score for a customer having or associated with the account: (1) age in months of the account; (2) average balance reduction over six months of the account; (3) bonus account indicator associated with the customer; (4) credit permission category associated with the customer; (5) gross income (in thousands of Yen) associated with the customer; (6) insurance type associated with the customer; (7) job type associated with the customer; (8) Lender Exchange (LE) trend associated with the customer; (9) number of loans in LE associated with the customer; (10) minimum remaining credit line ratio over three months for the account; (11) number of payments made to the account during the past three months; (12) number of loans made from the account during the past six months; (13) number of people in the customer's household; and (14) revolving agreement in effect indicator associated with the customer. Each of these variables will be discussed in more detail below. Each of these variables may have multiple variable categories. The final score may be the sum of these category variable values or by the weighted versions of these category variable values. For purposes of these example, the customer will be assumed to be in Japan, to receive an annual salary in Yen, and to have established an agreement that establishes an interest rate, maximum balance, etc. for a loan account. The loan account will be assumed to have a current balance of zero.

A Lender Exchange is a credit bureau that, among other things, may monitor and record the number, type, balances, etc. of loans associated with customers and may provide information regarding the number of loans associated with a customer that have positive or negative balances. For an entity implementing the method 100 and operating a financial account for a customer, a Lender Exchange may provide information regarding the number and total current balance of financial accounts established for the customer by other entities.

Information regarding the fourteen variables may be received during the step 102 and/or the step 104 or derived from the information and other data received during the step 102 and/or 104. The information and other data regarding the fourteen variables also may be received for a time period prior to the current implementation of the step 106. Thus, the method 100 may use data regarding an accounts and/or a customer generated over time to predict what the customer will do with the account in the future For purposes of this example, data will be calculated relative to a cutting point. In general, any previously generated or available data for an account and/or customer may be used. For purposes of the following example, information from as early as six months before the cutting point may be used for some variables.

Account Age in Months

For purposes of this examples the account age variable may be set up into six categories or bands as follows:

ACCAGE_{—}1 equals one if the account is eight months old or less, else ACCAGE_{—}1 equals zero.

ACCAGE_{—}2 equals one if the account is more than eight months old and is fifteen months old or less, else ACCAGE_{—}2 equals zero.

ACCAGE_{—}3 equals one if the account is more than fifteen months old and is twenty-five months old or less, else ACCAGE_{—}3 equals zero.

ACCAGE_{—}4 equals one if the account is more than twenty-five months old and is forty-two months old or less, else ACCAGE_{—}4 equals zero.

ACCAGE_{—}5 equals one if the account is more than forty-two months old and is one hundred and eight months old or less, else ACCAGE_{—}5 equals zero.

ACCAGE_{—}6 equals one if the account is more than one hundred and eight months old, else ACCAGE_{—}6 equals zero.

For this example, account age may be measured from the date a customer enters into an agreement to establish a loan account. Each of the six account age category variables ACCAGE_{—}1 through ACCAGE_{—}6 may have a different weighting factor associated with it, as will be discussed in more detail below. Only one of the six account age category variables will be equal to one at a time while the remaining account age category variables will be equal to zero.

Average Account Balance Reduction Over Six Months

For purposes of this example, the average account balance reduction over six months variable may relate to an average balance reduction trend over six months variable AVTRND6. The variable AVTRND6 may be computed as follows: If an account is less than six months old, AVTRND6 is considered “missing”. If the account is six months old or older and the number of balance reductions in the account over the past six months (RED6) is zero, then AVTRND6 equals zero.

If the account is six months old or older and the number of balance reductions over the past six months in the account (RED6) is greater than zero, then AVTRND6 is computed as follows: AVTRND6 equals SUM (BALTRND1 to BALTREND6) divided by RED6, where:

BALTRND(i) where i=1 to 5 is calculated as follows:

If BALANCE(i)=0, then BALTRND(i)=0;

Otherwise
BALTRND(i)=[balance(i)−balance(i+1)]/balance(i);

If BALTRND(i)<0 then BALTRND(i)=0.

BALANCE(1) is the balance in the account six months before the cutting point, BALANCE(2) is the balance in the account five months before the cutting point, BALANCE(3) is the balance in the account four months before the cutting point, etc.

The average account balance reduction over six months variable may be set up into six categories as follows:

AVBT6_{—}1 equals one if AVTRND6=0, or is “missing” else AVBT6_{—}1 equals zero.

AVBT6_{—}2 equals one if 0<AVTRND6<=0.0221, else AVBT6_{—}2 equals zero.

AVBT6_{—}3 equals one if 0.0221<AVTRND6<=0.0283, else AVBT6_{—}3 equals zero.

AVBT6_{—}4 equals one if 0.0283<AVTRND6<=0.1100, else AVBT6_{—}4 equals zero.

AVBT6_{—}5 equals one if 0.1100<AVTRND6<=0.4256, else AVBT6_{—}5 equals zero.

AVBT6_{—}6 equals one if 0.4256<AVTRND6, else AVBT6_{—}6 equals zero.

Each of the six category variables AVBT6_{—}1 through ABVT6_{—}6 may have a different weighting factor associated with it, as will be discussed in more detail below. Only one of the six average account balance reduction category variables will be equal to one while the remaining average balance reduction category variables will be equal to zero.

Bonus Account Indicator

For purposes of this example, the bonus account variable may be set up into two categories or bands as follows:

If a customer has no associated bonus accounts, then BONUS_{—}1 equals one, else BONUS_{—}1 equals zero.

If a customer has one or more associated bonus accounts (regardless of the size of bonus accounts), then BONUS_{—}2 equals one, else BONUS_{—}2 equals zero.

Each of the two bonus account category variables BONUS_{—}1 and BONUS_{—}2 may have a different weighting factor associated with it, as will be discussed in more detail below. Only one of the two bonus account category variables will be equal to one at a time while the other will be equal to zero.

Credit Permission Category

For purposes of this example, the credit permission category variable may be set up into two categories or bands as follows;

If a credit permission category (as described previously above) associated with the customer equals 2 or 3, then CREP_{—}1 equals one, else CREP_{—}1 equals zero.

If the credit permission category associated with the customer equals is not 2 or 3, then CREP_{—}2 equals one, else CREP_{—}2 equals zero.

Each of the two credit permission category variables CREP_{—}1 and CREP_{—}2 may have a different weighting factor associated with it, as will be discussed in more detail below. Only one of the two credit permission category variables will be equal to one while the other will be equal to zero.

Gross Income

For purposes of this example, the income variable may be set up into five categories or bands as follows:

If INCOMEG (measured in Yen) equals zero, then INCG_{—}1 equals one, else INCG_{—}1 equals zero.

If 0 Yen<INCOMEG <=3,500,000 Yen, then INCG_{—}2 equals one, else INCG_{—}2 equals zero.

If 3,500,000 Yen<INCOMEG <=4,000,000 Yen, then INCG_{—}3 equals one, else INCG_{—}3 equals zero.

If 4,000,000 Yen<INCOMEG <=5,000,000 Yen, then INCG_{—}4 equals one, else INCG_{—}4 equals zero.

If 5,000,000 Yen<INCOMEG, then INCG_{—}5 equals one, else INCG_{—}5 equals zero.

The variable INCOMEG equals a customer's yearly income measured in Yen. In other embodiments, other monetary denominations may be used instead of Yen.

Each of the five gross income category variables INCG_{—}1 through INCG_{—}5 may have a different weighting factor associated with it, as will be discussed in more detail below. Only one of the five gross income category variables will be equal to one while the remaining gross income category variables will be equal to zero.

Insurance Type

For purposes of this example, the insurance variable may be set up into two categories or bands as follows.

If the insurance type (as described previously above) associated with the customer equals 0, 1, 2, 3, or 7, then INS_{—}1 equals one, else INS_{—}1 equals zero.

If the insurance type associated with the customer equals 4, 5 or 6, then INS_{—}2 equals one, else INS_{—}2 equals zero.

Each of the two insurance category variables INS_{—}1 and INS_{—}2 may have a different weighting factor associated with it, as will be discussed in more detail below. Only one of the two insurance category variables will be equal to one while the other will be equal to zero.

Job Type

For purposes of this example, the job type variable may be set up into four categories or bands as follows:

If the job type associated with the customer, as described above, is 0 or 7, then JOBTY_{—}1 equals one, else JOBTY_{—}1 equals zero.

If the job type associated with the customer is 2, 4, 5, 8 or 12, then JOBTY_{—}2 equals one, else JOBTY_{—}2 equals zero.

If the job type associated with the customer is 6, 10, 11 or 13, then JOBTY_{—}3 equals one, else JOBTY_{—}3 equals zero.

If the job type associated with the customer is 1, 3 or 9, then JOBTY_{—}4 equals one, else JOBTY_{—}4 equals zero.

Each of the four job category variables JOBTY_{—}1 through JOBTY_{—}4 may have a different weighting factor associated with it, as will be discussed in more detail below. Only one of the four job category variables will be equal to one while the other three will be equal to zero.

LE Trend

For purposes of this example, the LE trend variable may be set up into four categories or bands as follows:

If −7<LEDELTA1<=−2, then LED_{—}1 equals one, else LED_{—}1 equals zero.

If −1<=LEDELTA1<=0, then LED_{—}2 equals one, else LED_{—}2 equals zero.

If LEDELTA2>0, then LED_{—}3 equals one, else LED_{—}3 equals zero.

LEDELTA1 captures the difference in the loans reported by a Lender Exchange (LE) over the past six months and can be measured as the number of loans at the cutting point minus the number of loans six months prior to the cutting point.

Each of the three LE trend category variables LED_{—}1 through LED_{—}3 may have a different weighting factor associated with it, as will be discussed in more detail below. Only one of the three category variables will be equal to one while the other two will be equal to zero.

Number of Loans in LE

For purposes of this example, the LE number variable may be set up into four categories or bands as follows:

If LE_NO5 equals zero, then LENO_{—}1 equals one, else LENO_{—}1 equals zero.

If LE_NO5 equals one, then LENO_{—}2 equals one, else LENO_{—}2 equals zero

If LE_NO5 is greater than one but less than or equal to five, then LENO_{—}3 equals one, else LENO_{—}3 equals zero.

If LE_NO5 is greater than five, then LENO_{—}4 equals one, else LENO_{—}4 equals zero.

Where LE_NO5 equals the total number of loans recorded by or in a Lender Exchange (a credit bureau) for the customer with a positive balance and is provided by the Lender Exchange.

Each of the four category variables LENO_{—}1 through LENO_{—}4 may have a different weighting factor associated with it, as will be discussed in more detail below. Only one of the four category variables will be equal to one while the other three will be equal to zero.

Minimum Remaining Credit Line Ratio

For purposes of this example, the minimum remaining credit line ratio over three months variable may be set up into five categories or bands as follows:

If MNCRDBL3<=0.0376 then MNL3_{—}1 equals one, else MNL3_{—}1 equals zero.

If 0.0376<MNCRDBL3<=0.2386 then MNL3_{—}2 equals one, else MNL3_{—}2 equals zero.

If 0.2386<MNCRDBL3<=0.6204 then MNL3_{—}3 equals one, else MNL3_{—}3 equals zero.

If 0.6204<MNCRDBL3<=0.8634 then MNL3_{—}4 equals one, else MNL3_{—}4 equals zero.

If 0.8634<MNCRDBL3 then MNL3_{—}5 equals one, else MNL3_{—}5 equals zero.

MNCRDBL3 equals the minimum of A(i) wherein i=4 to 6, where A(i) is calculated as follows:
A(i)=[CRDLINE_{—}5(i)−BALANCE(i)]/CRDLINE_{—}5(i)]

CRDLINE_{—}5(1) is the available credit line for the account six months before the cutting point, CRDLINE_{—}5(2) is the available credit line for the account five months before the cutting point, CREDLINE_{—}5(3) is the available credit line for the account four months before the cutting point, etc. BALANCE(1) is the balance in the account six months before the cutting point, BALANCE(2) is the balance in the account five months before the cutting point, etc.

Each of the five category variables MNL3_{—}1 through MNL3_{—}5 may have a different weighting factor associated with it, as will be discussed in more detail below. Only one of the five category variables will be equal to one at any given time while the other four will be equal to zero.

Number of Payments Made to the Account During Past Three Months

For purposes of this example, the number of payments made to the account during past three months variable may be set up into four categories or bands as follows:

If 0<=SUHCPL<=3 then NLN3_{—}1 equals one, else NLN3_{—}1 equals zero.

If SUHCPL=4 then NLN3_{—}2 equals one, else NLN3_{—}2 equals zero.

If SUHCPL=5 then NLN3_{—}3 equals one, else NLN3_{—}3 equals zero.

If SUHCPL>5, then NLN3_{—}4 equals one, else NLN3_{—}4 equals zero.

SUHCPL equals the number of payments made to or toward the account during the past three months.

Each of the four category variables NLN3_{—}1 through NLN3_{—}4 may have a different weighting factor associated with it, as will be discussed in more detail below. Only one of the four category variables will be equal to one at any given time while the other three will be equal to zero.

Number of Loans Made from the Account During Past Six Months

For purposes of this example, the number of loans made from the account during past six months variable may be set up into four categories or bands as follows:

If −6666<=SUHCL2<=0 then NUP6_{—}1 equals one, else NUP6_{—}1 equals zero.

If SUHCL2=1 then NUP6_{—}2 equals one, else NUP6_{—}2 equals zero.

If 1<SUHCL2<=6 then NUP6_{—}3 equals one, else NUP6_{—}3 equals zero.

If SUHCL2>6, then NUP6_{—}4 equals one, else NUP6_{—}4 equals zero.

SUHCL2 equals the number of loans made from the account during the past six months.

Each of the four category variables NUP6_{—}1 through NUP6_{—}4 may have a different weighting factor associated with it, as will be discussed in more detail below. Only one of the four category variables will be equal to one at any given time while the other three will be equal to zero.

Number of People in Customer's Household

For purposes of this example, the number of people in household variable may be set up into three categories or bands as follows:

If the number of people in the customer's household at the cutting point equals zero, then PEOP_{—}1 equals one, else PEOP_{—}1 equals zero.

If the number of people in the customer's household at the cutting point is more than zero but less than or equal to four, then PEOP_{—}2 equals one, else PEOP_{—}2 equals zero.

If the number of people in the customer's household at the cutting point is more than four, then PEOP_{—}3 equals one, else PEOP_{—}3 equals zero.

Each of the three category variables PEOP_{—}1 through PEOP_{—}3 may have a different weighting factor associated with it, as will be discussed in more detail below. Only one of the three category variables will be equal to one at any given time while the other two will be equal to zero.

Revolving Agreement in Effect Indicator

For purposes of this example, the revolving agreement in effect variable may be set up into two categories or bands as follows:

If REV_AGR equals zero, then REVAG_{—}1 equals one, else REVAG_{—}1 equals zero.

If REV_AGR equals one, then REVAG_{—}2 equals one, else REVAG_{—}2 equals zero.

REV_AGR equals one if the agreement with the customer is a revolving loan agreement and REV_AGR equals zero if the agreement with the customer is a non-revolving loan agreement.

Each of the two category variables REVAG_{—}1 and REVAG_{—}2 may have a different weighting factor associated with it, as will be discussed in more detail below. Only one of the two category variables will be equal to one at any given time while the other will be equal to zero.

Weights

As illustrated above, each of the fourteen variables may have multiple categories or bands associated with each category or band may have a weight associated with it as illustrated in Table 1.

TABLE 1

| | Category | |
|---|---|---|
| Variable | Variable Name | Weight |
| Account Age | ACCAGE_1 | 0.2773 |
| Account Age | ACCAGE_2 | 0.1633 |
| Account Age | ACCAGE_3 | 0 |
| Account Age | ACCAGE_4 | 0 |
| Account Age | ACCAGE_5 | −0.1194 |
| Account Age | ACCAGE_6 | 0 |
| Average Balance Reduction | AVBT6_1 | 0 |
| Over Six Months | | |
| Average Balance Reduction | AVBT6_2 | 0 |
| Over Six Months | | |
| Average Balance Reduction | AVBT6_3 | 0 |
| Over Six Months | | |
| Average Balance Reduction | AVBT6_4 | −0.0758 |
| Over Six Months | | |
| Average Balance Reduction | AVBT6_5 | 0 |
| Over Six Months | | |
| Average Balance Reduction | AVBT6_6 | 0.2781 |
| Over Six Months | | |
| Bonus Account | BONUS_1 | 0 |
| Bonus Account | BONUS_2 | 0.4598 |
| Credit Permission Category | CREP_1 | 0 |
| Credit Permission Category | CREP_2 | −0.1209 |
| Gross Income | INCG_1 | 0 |
| Gross Income | INCG_2 | 0 |
| Gross Income | INCG_3 | 0 |
| Gross Income | INCG_4 | 0.1706 |
| Gross Income | INCG_5 | 0.2164 |
| Insurance Type | INS_1 | 0 |
| Insurance Type | INS_2 | 0.2579 |
| Job Type | JOBTY_1 | −0.197 |
| Job Type | JOBTY_2 | −0.1648 |
| Job Type | JOBTY_3 | 0 |
| Job Type | JOBTY_4 | 0.3584 |
| LE Trend | LED_1 | 0 |
| LE Trend | LED_2 | 0 |
| LE Trend | LED_3 | 0.3766 |
| LE Trend | LED_4 | 0 |
| Number of Loans in LE | LENO_1 | 0 |
| Number of Loans in LE | LENO_2 | 0 |
| Number of Loans in LE | LENO_3 | 0.141 |
| Number of Loans in LE | LENO_4 | 0 |
| Minimum Remaining Credit | MNL3_1 | 0.263 |
| Line Ratio | | |
| Minimum Remaining Credit | MNL3_2 | 0 |
| Line Ratio | | |
| Minimum Remaining Credit | MNL3_3 | −0.1217 |
| Line Ratio | | |
| Minimum Remaining Credit | MNL3_4 | −0.2042 |
| Line Ratio | | |
| Minimum Remaining Credit | MNL3_5 | −0.3008 |
| Line Ratio | | |
| Number of Payments in Past | NLN3_1 | −0.0753 |
| Three Months | | |
| Number of Payments in Past | NLN3_2 | 0 |
| Three Months | | |
| Number of Payments in Past | NLN3_3 | 0 |
| Three Months | | |
| Number of Payments in Past | NLN3_4 | 0.1398 |
| Three Months | | |
| Number of Loans in Past Six | NUP6_1 | −0.9011 |
| Months | | |
| Number of Loans in Past Six | NUP6_2 | −0.3334 |
| Months | | |
| Number of Loans in Past Six | NUP6_3 | 0 |
| Months | | |
| Number of Loans in Past Six | NUP6_4 | 0.3195 |
| Months | | |
| Number of People in Customer's | PEOP_1 | −0.0968 |
| Household | | |
| Number of People in Customer's | PEOP_2 | 0 |
| Household | | |
| Number of People in Customer's | PEOP_3 | 0 |
| Household | | |
| Revolving Agreement | REVAG_1 | 0 |
| Revolving Agreement | REVAG_2 | 1.5439 |

As illustrated by the previous chart, some weights may be equal to zero. A zero weight may be indicative of a lack of statistical significance of the weight's associated variable. Since each of the fourteen variables will have one of their categories or bands equal to one and the rest equal to zero, the score for the variables may be equal to the total of the weights corresponding to non-zero category variables. In some embodiments, one or more variables illustrated in Table 1 may have a non-zero value but the variable(s) may not be used to compute the score. For example, in some embodiments, only the variables ACCAGE_{—}1, ACCAGE_{—}2, and ACCAGE_{—}5 may be used from the account age variable category.

As previously discussed above, all of the category variables in Table 1 will have either a value of zero or one. In addition, only one category variable for each variable will have a value of one while the remaining variables for the variable will have a value of zero. For example, the account age variable has six category variables, namely ACCAGE_{—}1, ACCAGE_{—}2, ACCAGE_{—}3, ACCAGE_{—}4, ACCAGE_{—}5, and ACCAGE_{—}6, only one of which will be equal to one while the other five are equal to zero. Three of the six account age category variables (i.e., ACCAGE_{—}3, ACCAGE_{—}4, and ACCAGE_{—}6) have associated weights equal to zero.

Thus, a score for a customer can be found by multiplying the category variable values by the associated weights and summing the total. For example, one possible score is illustrated in Table 2.

TABLE 2

| | | | | Weighted |
|---|---|---|---|---|
| | Category | Category | | Category |
| | Variable | Variable | | Variable |
| Variable | Name | Value | Weight | Score |
| Account Age | ACCAGE_1 | 0 | 0.2773 | 0 |
| Account Age | ACCAGE_2 | 0 | 0.1633 | 0 |
| Account Age | ACCAGE_3 | 0 | 0 | 0 |
| Account Age | ACCAGE_4 | 0 | 0 | 0 |
| Account Age | ACCAGE_5 | 1 | −0.1194 | −0.1194 |
| Account Age | ACCAGE_6 | 0 | 0 | 0 |
| Average Balance | AVBT6_1 | 0 | 0 | |
| Reduction Over Six | | | | |
| Months | | | | |
| Average Balance | AVBT6_2 | 1 | 0 | 0 |
| Reduction Over Six | | | | |
| Months | | | | |
| Average Balance | AVBT6_3 | 0 | 0 | 0 |
| Reduction Over Six | | | | |
| Months | | | | |
| Average Balance | AVBT6_4 | 0 | −0.0758 | 0 |
| Reduction Over Six | | | | |
| Months | | | | |
| Average Balance | AVBT6_5 | 0 | 0 | 0 |
| Reduction Over Six | | | | |
| Months | | | | |
| Average Balance | AVBT6_6 | 0 | 0.2781 | 0 |
| Reduction Over Six | | | | |
| Months | | | | |
| Bonus Account | BONUS_1 | 0 | 0 | 0 |
| Bonus Account | BONUS_2 | 1 | 0.4598 | 0.4598 |
| Credit Permission | CREP_1 | 0 | 0 | 0 |
| Category | | | | |
| Credit Permission | CREP_2 | 1 | −0.1209 | −0.1209 |
| Category | | | | |
| Gross Income | INCG_1 | 0 | 0 | 0 |
| Gross Income | INCG_2 | 0 | 0 | 0 |
| Gross Income | INCG_3 | 0 | 0 | 0 |
| Gross Income | INCG_4 | 1 | 0.1706 | 0.1706 |
| Gross Income | INCG_5 | 0 | 0.2164 | 0 |
| Insurance Type | INS_1 | 1 | 0 | 0 |
| Insurance Type | INS_2 | 0 | 0.2579 | 0 |
| Job Type | JOBTY_1 | 1 | −0.197 | −0.197 |
| Job Type | JOBTY_2 | 0 | −0.1648 | 0 |
| Job Type | JOBTY_3 | 0 | 0 | 0 |
| Job Type | JOBTY_4 | 0 | 0.3584 | 0 |
| LE Trend | LED_1 | 0 | 0 | 0 |
| LE Trend | LED_2 | 0 | 0 | 0 |
| LE Trend | LED_3 | 0 | 0.3766 | 0 |
| LE Trend | LED_4 | 1 | 0 | 0 |
| Number of Loans in LE | LENO_1 | 0 | 0 | 0 |
| Number of Loans in LE | LENO_2 | 0 | 0 | 0 |
| Number of Loans in LE | LENO_3 | 1 | 0.141 | 0.141 |
| Number of Loans in LE | LENO_4 | 0 | 0 | 0 |
| Minimum Remaining | MNL3_1 | 1 | 0.263 | 0.263 |
| Credit Line Ratio | | | | |
| Minimum Remaining | MNL3_2 | 0 | 0 | 0 |
| Credit Line Ratio | | | | |
| Minimum Remaining | MNL3_3 | 0 | −0.1217 | 0 |
| Credit Line Ratio | | | | |
| Minimum Remaining | MNL3_4 | 0 | −0.2042 | 0 |
| Credit Line Ratio | | | | |
| Minimum Remaining | MNL3_5 | 0 | −0.3008 | 0 |
| Credit Line Ratio | | | | |
| Number of Payments in | NLN3_1 | 0 | −0.0753 | 0 |
| Past Three Months | | | | |
| Number of Payments in | NLN3_2 | 1 | 0 | 0 |
| Past Three Months | | | | |
| Number of Payments in | NLN3_3 | 0 | 0 | 0 |
| Past Three Months | | | | |
| Number of Payments in | NLN3_4 | 0 | 0.1398 | 0 |
| Past Three Months | | | | |
| Number of Loans in Past | NUP6_1 | 0 | −0.9011 | 0 |
| Six Months | | | | |
| Number of Loans in Past | NUP6_2 | 1 | −0.3334 | −0.3334 |
| Six Months | | | | |
| Number of Loans in Past | NUP6_3 | 0 | 0 | 0 |
| Six Months | | | | |
| Number of Loans in Past | NUP6_4 | 0 | 0.3195 | 0 |
| Six Months | | | | |
| Number of People in | PEOP_1 | 0 | −0.0968 | 0 |
| Customer's Household | | | | |
| Number of People in | PEOP_2 | 1 | 0 | 0 |
| Customer's Household | | | | |
| Number of People in | PEOP_3 | 0 | 0 | 0 |
| Customer's Household | | | | |
| Revolving Agreement | REVAG_1 | 0 | 0 | 0 |
| Revolving Agreement | REVAG_2 | 1 | 1.5439 | 1.5439 |

In some cases, an adjustment or intercept or amount score may be added to increase the total score. The total score for this customer may be found by totaling the weighted variable scores in the far right hand column of Table 2 and is equal to 1.8076. Generally, the higher the score, the more likely a customer is to reuse a financial account.

During a step 108, a course of action is selected or otherwise determined based, at least in part, on the score determined during the step 106. In some embodiments, the step 108 is optional and may not be used. As previously discussed above, a course of action may include a marketing or promotional activity directed toward or for the benefit of a customer. For example, a customer who is considered likely to reuse or reactivate an account may not have additional marketing efforts directed toward him or her. In contrast, a customer who is not considered likely to reactivate or reuse a loan account may have marketing efforts directed to him or her in an attempt to persuade the customer to use or otherwise reactivate the loan account. Alternatively, a customer who is not likely to reactivate or reuse a loan account may have marketing efforts directed to him or her in an attempt to persuade the customer establish a different financial account, a credit card, etc. so that interest or other payments may be received from the customer via other financial products.

In the previous examples, a threshold or percentile score or above may indicate that the customer is more likely than not to reuse a financial account currently having a zero balance while a score below the threshold score may indicate that the customer is not likely to reuse the financial account. A threshold score may be determined over time as analysis is conducted. For the previous example, a score of 0.259 may represent the seventy-fifth percentile (i.e., seventy-five percent of customers have a score equal to or less than 0.259) while a score of minus 1.162 may represent the twenty-fifth percentile. Different percentile scores for different customers may result in different courses of action being taken with regard to the different customers.

In some embodiments, the method 100 may include receiving or otherwise determining data indicative of the algorithm, model, heuristic, procedure, expert system, rule, etc. to be used during the step 106, providing the score or information regarding the score determined during the step 106 to another party or device, providing information regarding the course of action determined during the step 108 to another party or device, implementing or conducting the course of action determined during the step 108, terminating or closing a financial account, providing any or all of the data determined during the step 102 and/or the step 104 to another party or device, providing any or all of the data used or determined during the step 106 to another party or device, updating a database regarding information regarding a customer, financial account, score, receiving a payment for a financial account, facilitating a withdrawal for a financial account, etc., confirming receipt of the data received during the step 102 and/or the step 104, etc.

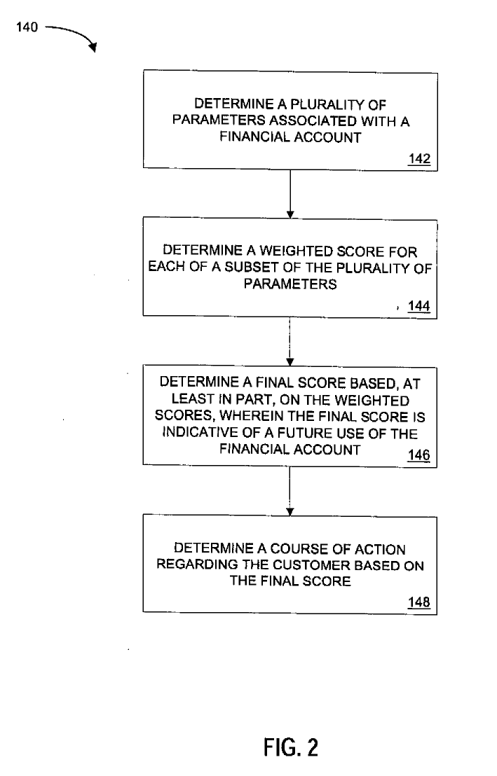

Reference is now made to FIG. 2, where a flow chart 140 is shown which represents the operation of a second embodiment of the present invention. The particular arrangement of elements in the flow chart 140 is not meant to imply a fixed order to the steps; embodiments of the present invention can be practiced in any order that is practicable. In some embodiments, some or all of the steps of the method 140 may be performed or completed by a server, user device and/or another device, as will be discussed in more detail below.

Processing begins at a step 142 during which a plurality of parameters are determined regarding a customer and/or a financial account associated with the customer. The step 142 is similar to the steps 102 and 104 previously discussed above. Information or other data regarding one or more parameters may be received via an electronic signal or communication from one or more sources.

The parameters determined during the step 142 may include customer and/or financial account data or parameters, such as the parameters previously discussed above. Some or all of the plurality of parameters may be known in advance or identified over time. For example, a model may use one or more parameters or predictor variables that have, over a period of time, been shown or found to be statistically significant in predicting a customer's actions regarding a financial account (e.g., in predicting whether a customer likely to reactivate or reuse a loan account having a zero balance).

During a step 144, a weighted score is determined for each of a subset of the plurality of parameters determined during the step 142. In some embodiments, the subset may be a proper subset of the parameters. In other embodiments, the subset may include all of the parameters determined during the step 142. The weights for particular variables may be used as previously discussed above in Table 2 to create a weighted score.

During a step 146, a final score is determined based on some or all of the weighted parameters determined during the step 144. A final score may be determined in accordance with an algorithm, model, heuristic, procedure, expert system, rule, etc. In some embodiments, the final score may be the total of some or all of the weighted scores determined during the step 144. The score determined during the step 146 may be indicative of a customer's likelihood of reactivating or reusing the financial account. Furthermore, the score may be indicative of the customer's likelihood of reactivating or reusing the financial account when the customer meets a designated criterion (e.g., the customer's balance in the financial account is zero or near zero).

During a step 148, a course of action is selected or otherwise determined based, at least in part, on the final score determined during the step 146. The step 148 is similar to the step 108 previously discussed above.

In some embodiments, the method 140 may include receiving or otherwise determining data indicative of the algorithm, model, heuristic, procedure, expert system, rule, etc. to be used during the step 146, providing the score or information regarding the final score determined during the step 146 to another party or device, providing information regarding the course of action determined during the step 148 to another party or device, implementing or conducting the course of action determined during the step 148, terminating or closing a financial account, providing information regarding any or all of the parameters determined during the step 142 to another party or device, updating a database regarding information regarding a customer, financial account, score, etc., providing information regarding one or more of the weighted scores determined during the step 144 to one or more devices or entities, receiving a payment for a financial account, facilitating a withdrawal for a financial account, etc.

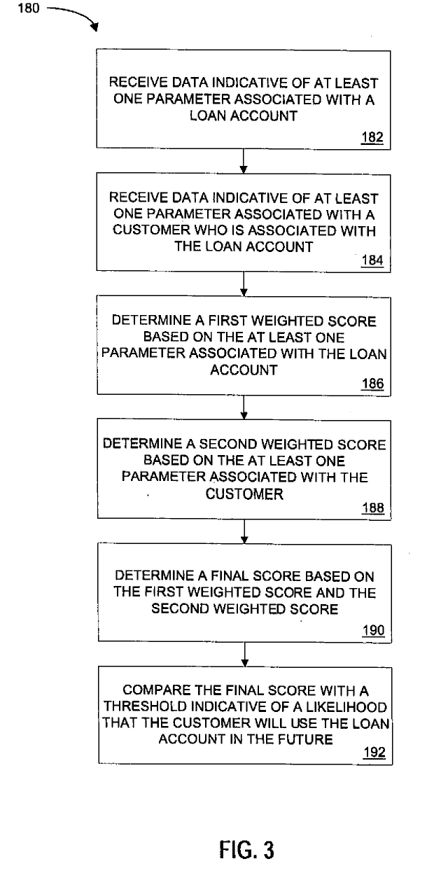

Reference is now made to FIG. 3, where a flow chart 180 is shown which represents the operation of a third embodiment of the present invention. The particular arrangement of elements in the flow chart 180 is not meant to imply a fixed order to the steps; embodiments of the present invention can be practiced in any order that is practicable. In some embodiments, some or all of the steps of the method 180 may be performed or completed by a server, user device and/or another device, as will be discussed in more detail below.

Processing begins at a step 182 during which information or other data is received or otherwise determined that is indicative of at least one parameter associated with a loan or other financial account. The step 182 is similar to the steps 104 and 142 previously discussed above.

During a step 184, information or other data is received or otherwise determined that is indicative of at least one parameter associated with the loan or other financial account involved in the step 182. The step 184 is similar to the steps 102 and 142 previously discussed above.

In some embodiments, the step 184 may be initiated or completed simultaneously with the step 182, as part of the step 182, or before the step 182. Thus, in some embodiments, the steps 182 and 184 may be initiated or completed as a single step.

During a step 186, a weighted score is determined for at least one (but two or more or all) of the parameters determined during the step 182. In some embodiments, the step 186 may be initiated or completed prior to or simultaneously with the step 184. The step 186 is similar to that portion of the step 144 previously discussed above dealing with the determination of a weighted score for a parameter associated with a financial account.

During a step 188, a weighted score is determined for at least one of the parameters determined during the step 184. In some embodiments, the step 188 may be initiated or completed prior to or simultaneously with the step 186. The step 188 is similar to that portion of the step 144 previously discussed above dealing with the determination of a weighted score for a parameter associated with a customer.

During a step 190, a final score is determined based, at least in part, on the weighted scores determined during the steps 186 and 188. The step 190 is similar to the step 146 previously discussed above.

During a step 192, a comparison is made with the final score determined during the step 190 with a threshold score indicative of the likelihood of whether or not the customer will reactivate or reuse the financial account. Different scoring or weighting systems, different customers, different financial accounts, etc., may have different threshold scores. In some embodiments, the step 192 may be optional and not used or completed as part of the method 180.

In some embodiments, the method 180 may include a step during which a course of action is selected or otherwise determined based, at least in part, on the final score determined during the step 190 and/or the comparison made during the step 192.

In some embodiments, the method 180 may include receiving or otherwise determining data indicative of the algorithm, model, heuristic, procedure, expert system, rule, etc. to be used during the step 186, the step 188 and/or the step 190, providing the score or information regarding the scores determined during the step 186, the step 188 and/or the step 190 to another party or device, providing information regarding a course of action to another party or device, implementing or conducting a course of action, terminating or closing a financial account, providing information regarding any or all of the parameters determined during the step 182 and/or 184 to another party or device, updating a database regarding information regarding a customer, financial account, score, etc., providing information regarding one or more of the weighted scores determined during the step 186 and/or the step 188 to one or more devices or entities, receiving a payment for a financial account, facilitating a withdrawal for a financial account, confirming receipt of the data received during the step 182 and/or the step 184, etc.

System

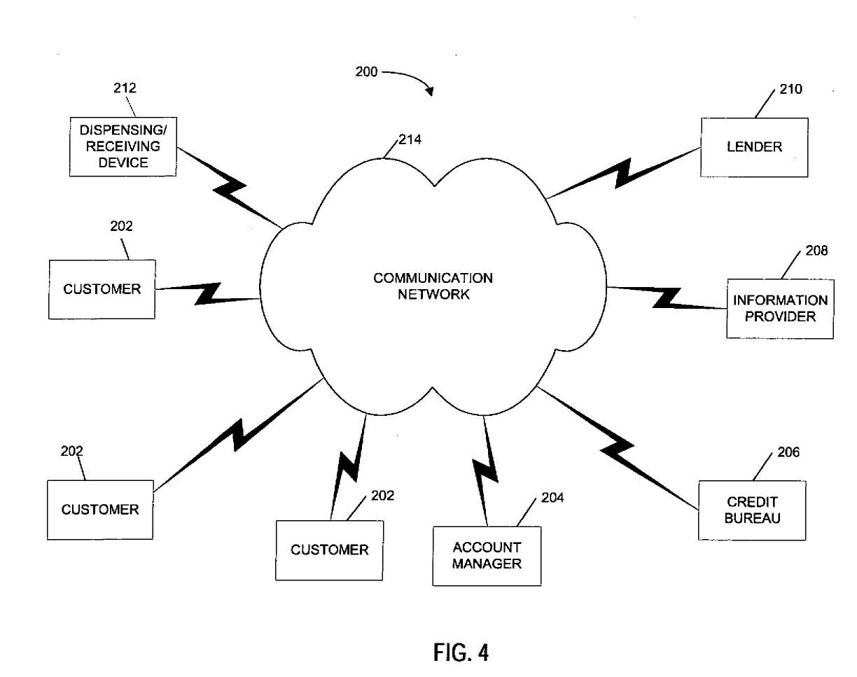

Now referring to FIG. 4, an apparatus or system 200 usable with the methods disclosed herein is illustrated.

The apparatus 200 includes one or more customer (also referred to as customer devices) 202 that may communicate directly or indirectly with an account manager 204 via a computer, data, or communications network 214. In addition, the apparatus 200 may include a credit bureau 206 (also referred to herein as a credit bureau device), an information provider (also referred to herein as an information provider device), a lender (also referred to herein as a lender device), and a dispensing/receiving device 212.

For purposes of further explanation and elaboration of the methods disclosed herein, the methods disclosed herein will be assumed to be operating on, or under the control of, the account manager 204.

The account manager 204 may implement or host a Web site. An account manager device 204 can comprise a single device or computer, a networked set or group of devices or computers, a workstation, etc. In some embodiments, an account manager device 204 also may function as a database server and/or as a user device. The use, configuration and operation of account managers will be discussed in more detail below.

The customer devices 202 preferably allow customers to interact with the account manager 204 and the remainder of the apparatus 200. The customer devices 202 also may enable a user to access Web sites, software, databases, etc. Possible customer devices include a personal computer, portable computer, mobile or fixed user station, workstation, network terminal or server, cellular telephone, kiosk, dumb terminal, personal digital assistant, etc. In some embodiments, information regarding one or more customers and/or one or more customer devices may be stored in, or accessed from, a customer information database and/or a customer device information database.

The credit bureau 206 may provide credit rating or credit history information to the account manager 204 regarding one or more customers on a continuous, periodic, or random basis.

The information provider 208 may be or include any entity that provides information of any kind to the account manager 204 regarding one or more customers and/or one or more accounts. The information provider 208 may provide such information on a continuous, or random basis. In some embodiments, an information provider 208 may be a lender 210, government agency, or credit bureau 206.

The lender 210 may provide information to the account manager regarding one or more additional loans or financial products provided to one or more customers. The lender 210 may provide such information on a continuous, or random basis.

The dispensing/receiving device 212 may allow a customer to receive or withdrawal monies or funds from an account or to make one or more payments towards the balance of an account. A dispensing/receiving device 212 may be in communication with a bank, lender or the account manager to ascertain current account balances. A dispensing/receiving device 212 may be or include an ATM (automated teller machine), kiosk or other suitable device.

Many different types of implementations or hardware configurations can be used in the system 200 and with the methods disclosed herein and the methods disclosed herein are not limited to any specific hardware configuration for the system 200 or any of its components. In addition, not all of the parties illustrated in the system 200 may be needed for each embodiment or implementation of the methods disclosed herein.

The communications network 214 might be or include the Internet, the World Wide Web, or some other public or private computer, cable, telephone, client/server, peer-to-peer, or communications network or intranet, as will be described in further detail below. The communications network 214 illustrated in FIG. 4 is meant only to be generally representative of cable, computer, telephone, peer-to-peer or other communication networks for purposes of elaboration and explanation of the present invention and other devices, networks, etc. may be connected to the communications network 214 without departing from the scope of the present invention. The communications network 214 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a customer device or other device may be connected directly to the account manager 204 without departing from the scope of the present invention. Moreover, as used herein, communications include those enabled by wired or wireless technology.

In some embodiments, a suitable wireless communication network 214 may include the use of Bluetooth technology, allowing a wide range of computing and telecommunication devices to be interconnected via wireless connections. Specifications and other information regarding Bluetooth technology are available at the Bluetooth Internet site www.bluetooth.com. In embodiments utilizing Bluetooth technology, some or all of the devices of FIG. 4 may be equipped with a microchip transceiver that transmits and receives in a previously unused frequency band of 2.45 GHz that is available globally (with some variation of bandwidth in different countries). Connections can be point-to-point or multipoint over a current maximum range often (10) meters. Embodiments using Bluetooth technology may require the additional use of one or more receiving stations to receive and forward data from individual user devices 202 or servers 204.

The devices shown in FIG. 4 need not be in constant communication. For example, a customer may communicate with the account manager 204 only when such communication is appropriate or necessary.

Account Manager

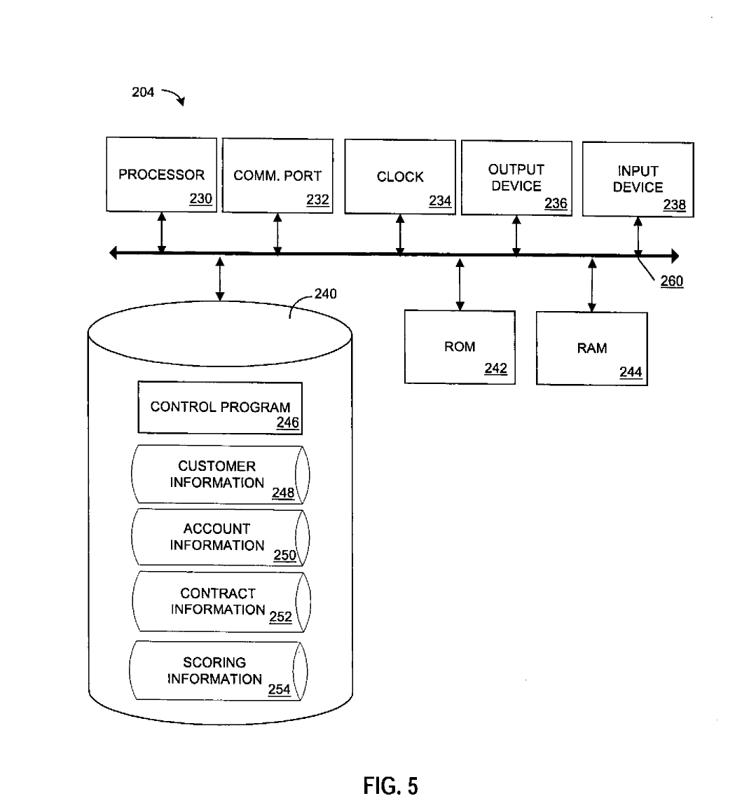

Now referring to FIG. 5, a representative block diagram of an account manager device 204 (hereinafter referred to as a server or controller 204) is illustrated. The server 204 may include a processor, microchip, central processing unit, or computer 230 that is in communication with or otherwise uses or includes one or more communication ports 232 for communicating with user devices and/or other devices. Communication ports may include such things as local area network adapters, wireless communication devices, Bluetooth technology, etc. The server 204 also may include an internal clock element 234 to maintain an accurate time and date for the server 204, create time stamps for communications received or sent by the server 204, etc.

If desired, the server 204 may include one or more output devices 236 such as a printer, infrared or other transmitter, antenna, audio speaker, display screen or monitor, text to speech converter, etc., as well as one or more input devices 238 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 204 may include a memory or data storage device 240 to store information, software, databases, communications, device drivers, customers, factors or other parameters, financial accounts, scores, scoring algorithms, etc. The memory or data storage device 240 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The server 204 also may include separate ROM 242 and RAM 244.

The processor 230 and the data storage device 240 in the server 204 each may be, for example: (i) located entirely within a single computer or other computing device; or (ii) connected to each other by a remote communication medium, such as a serial port cable, telephone line or radio frequency transceiver. In one embodiment, the server 204 may comprise one or more computers that are connected to a remote server computer for maintaining databases.

A conventional personal computer or workstation with sufficient memory and processing capability may be used as the server 204. In one embodiment, the server 204 operates as or includes a Web server for an Internet environment. The server 204 may be capable of high volume transaction processing, performing a significant number of mathematical calculations in processing communications and/or database searches. A Pentium™ microprocessor such as the Pentium III™ or IV™ microprocessor, manufactured by Intel Corporation may be used for the processor 230. Equivalent processors are available from Motorola, Inc., AMD, or Sun Microsystems, Inc. The processor 230 also may comprise one or more microprocessors, computers, computer systems, etc.

Software may be resident and operating or operational on the server 204. The software may be stored on the data storage device 240 and may include a control program 246 for operating the server, databases, etc. The control program 246 may control the processor 230. The processor 230 preferably performs instructions of the control program 246, and thereby operates in accordance with the present invention, and particularly in accordance with the methods described in detail herein. The control program 246 may be stored in a compressed, uncompiled and/or encrypted format. The control program 246 furthermore includes program elements that may be necessary, such as an operating system, a database management system and device drivers for allowing the processor 220 to interface with peripheral devices, databases, etc. Appropriate program elements are known to those skilled in the art, and need not be described in detail herein.

The server 204 also may include or store information regarding customers, accounts, contracts, scores, scoring algorithms, communications, etc. For example, information regarding one or more customer may be stored in a customer information database 248 for use by the server 204 or another device or entity. Information regarding one or more accounts may be stored in an account information database 250 for use by the server 204 or another device or entity and information regarding one or more contracts may be stored in a contract information database 252 for use by the server 204 or another device or entity. Information regarding one or more scores and/or scoring algorithms may be stored in a scoring information database 254. In some embodiments, some or all of one or more of the databases may be stored or mirrored remotely from the server 204.

According to an embodiment of the present invention, the instructions of the control program may be read into a main memory from another computer-readable medium, such as from the ROM 242 to the RAM 244. Execution of sequences of the instructions in the control program causes the processor 230 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 230, communication port 232, clock 234, output device 236, input device 238, data storage device 240, ROM 242, and RAM 244 may communicate or be connected directly or indirectly in a variety of ways. For example, the processor 230, communication port 232, clock 234, output device 236, input device 238, data storage device 240, ROM 242, and RAM 244 may be connected via a bus 260.

While specific implementations and hardware configurations for servers 204 have been illustrated, it should be noted that other implementations and hardware configurations are possible and that no specific implementation or hardware configuration is needed. Thus, not all of the components illustrated in FIG. 5 may be needed for a server implementing the methods disclosed herein. Therefore, many different types of implementations or hardware configurations can be used in the system 200 and the methods disclosed herein are not limited to any specific hardware configuration.

Databases

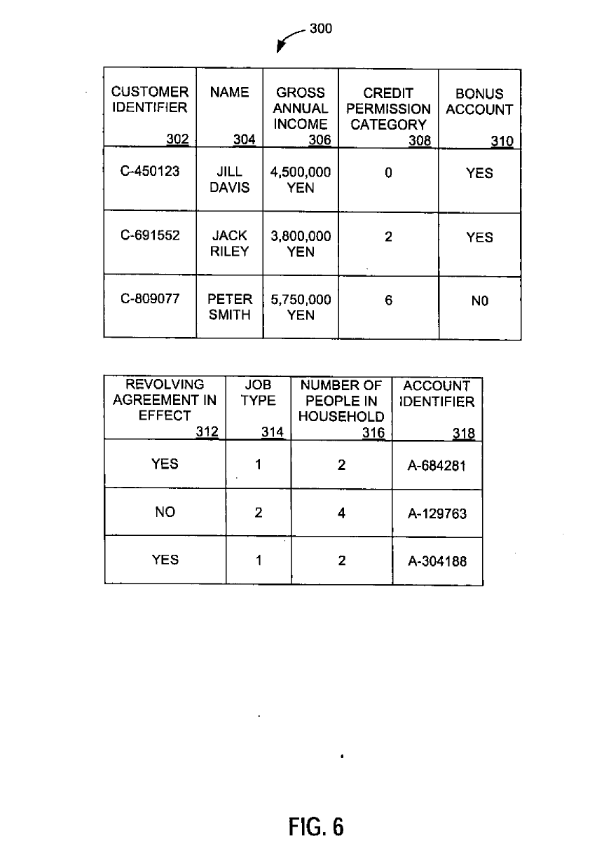

As previously discussed above, in some embodiments a server, user device, or other device may include or access a customer information database for storing or keeping information regarding one or more customer. One representative customer information database 300 is illustrated in FIG. 6.

The customer information database 300 may include a customer identifier field 302 that may include codes or other identifiers for one or more customers, a customer name 304 field that may include names or other descriptive information for the customers identified in the field 300, an income field 306 that may include information regarding the incomes of the customers identified in the field 302, a credit permission category field 308 that may include identifiers or other information regarding credit permission categories associated with the customers identified in the field 302, a bonus account field 310 that may include information regarding bonus accounts associated with the customers identified in the field 302, a revolving agreement in effect field 312 that may include information regarding one or more revolving agreements associated with the customers identified in the field 302, a job type field 314 that may include identifiers or other information regarding one or more job types associated with the customers identified in the field 302, a number of people in household field 316 that may include information regarding the household demographics of the customers identified in the field 302, and an account identifier field 316 that may include identifiers or other information regarding one or more accounts associated with the customers identified in the field 302.

Other or different fields also may be used in the customer information database 300. For example, in some embodiments the customer information database may include address, telephone number, age, race, gender, loan channels, marital status, or other demographic or social information for the customers identified in the field 302.

As illustrated by the customer information database 300 of FIG. 6, the customer identified as “C-450123” in the field 302 is named “JILL DAVIS” and has an annual income of “4,500,000 YEN”, a credit permission category of “0”, at least one associated bonus account, a job type of “1”, and two people in or at least associated with her household. The customer identified as “C-450123” in the field 302 also is associated with the account identified as “A-684281”.

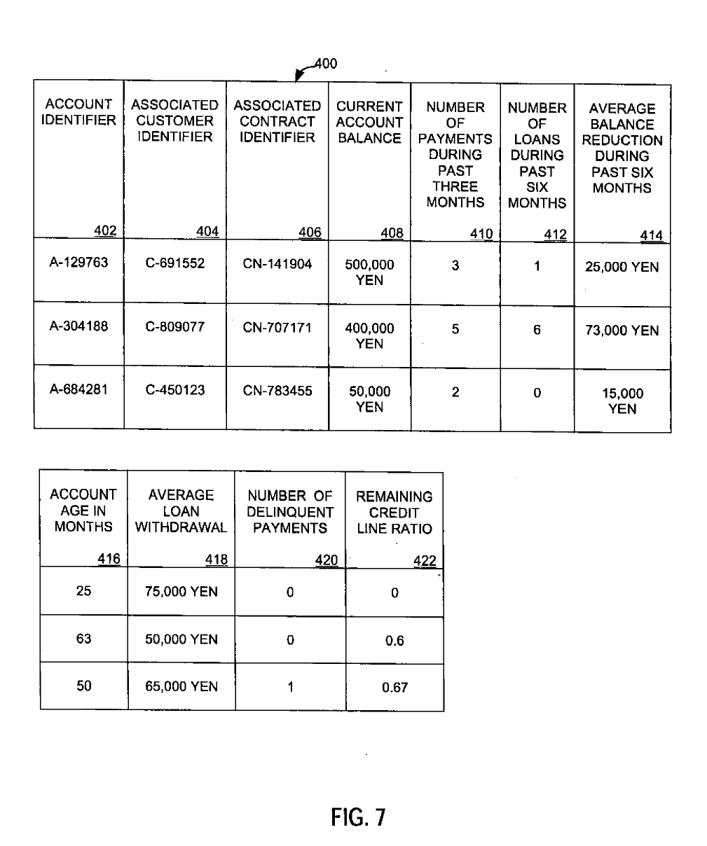

As previously discussed above, in some embodiments a server, user device, or other device may include or access an account information database for storing or keeping information regarding one or more accounts. One representative account information database 400 is illustrated in FIG. 7.

The account information database 400 may include an account identifier field 402 that may include codes or other identifiers for one or more accounts, an associated customer identifier field 404 that may include codes or other identifiers for customers associated with the accounts identified in the field 402, an associated contract identifier field 406 that may include codes or other identifiers for one or more contracts associated with the account identified in the field 402, a current account balance field 408 that may include information regarding the current balances of the accounts identified in the field 402, a number of payments made during the past three months field 410 that may include information regarding the number of payments made by the customers identified in the field 404 for the accounts identified in the field 402, a number of loans during the past six months field 412 that may include information regarding the number of loans or withdrawals made by the customers identified in the field 404 via the accounts identified in the field 402, an average balance reduction field 414 that may include information regarding the average balance reduction during the previous six months for the accounts identified in the field 402, an account age field 416 that may include information regarding the age (in months) of the accounts identified in the field 402, an average loan withdrawal field 418 that may include information regarding the average loan or withdrawal made in the accounts identified in the field 402, a delinquent payments field 420 that may include information regarding the number of delinquent payments incurred by the customers identified in the field 404 for the accounts identified in the field 402, and a remaining credit line ratio field 422 that may include information regarding usage of the accounts identified in the field 402.

Other or different fields also may be used in the account information database 400. For example, in some embodiments the account information database 400 may include information regarding when, how and/or where payments are made to an account, information regarding when, how and/or where withdrawals are made from an account, information regarding average payments, information regarding credit utilization ratios for accounts, etc.

As illustrated by the account information database 400 of FIG. 7, the account identified as “A-129763” in the field 402 is associated with a customer identified as “C-691552” and a contract identified as “CN-141904”. The account identified as “A-129763” has a current balance of “500,000 YEN” and has been in existence for twenty-five months. In addition, three payments to reduce the balance of the account have been made during the past three months while one loan or withdrawal has been made from the account during the past six months. The average loan or withdrawal made for the account is “75,000 YEN” and there have been no delinquent payments incurred by the customer “C-691552” with the account. The account identified as “A-129763” has a current remaining credit line ratio of zero and an average balance reduction over six months of “25,000 YEN”.

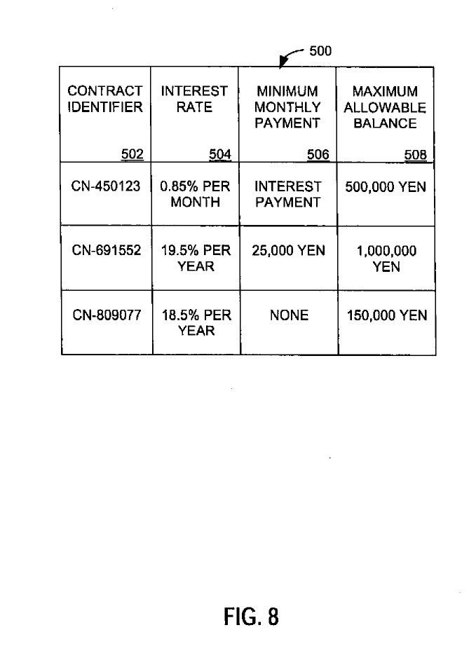

As previously discussed above, in some embodiments a server, user device, or other device may include or access a contract information database for storing or keeping information regarding one or more contracts. One representative contract information database 500 is illustrated in FIG. 8. In some embodiments, a contract information database may be part of or included in an account information database.

The contract information database 500 may include a contract identifier field 502 that may include codes or other identifiers for one or more contracts, an interest rate field 504 that may include information regarding interest rates associated with the contracts identified in the field 502, a minimum monthly payment field 506 that may include information regarding minimum monthly payments required for the contracts identified in the field 502, and a maximum allowable balance field 508 that may include information regarding the maximum sizes of loans that can be made via the contracts identified in the field 502.

Other or different fields also may be used in the contract information database 500. For example, in some embodiments a contract information database may include information regarding when a contract was established, information regarding a maximum term associated with a loan, information regarding collateral if a contract provides for a secured loan, information regarding one or more banks, customers, lenders or other entities associated with the contracts identified in the field 502, information regarding, etc.

As illustrated by the contract information database 500 of FIG. 8, the contract identified as “CN-691552” in the field 502 has an interest rate of “19.5% PER YEAR”, a minimum monthly payment of “25,000 YEN” and a maximum allowable balance of “1,000,000 YEN” associated with it.

As previously discussed above, in some embodiments a server, user device, or other device may include or access a scoring information database for storing or keeping information regarding one or more scores, scoring algorithms, etc. One representative scoring information database is exemplified by Table 1 previously discussed above.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

1-32. (canceled)

33. A method comprising:
determining that a customer has a zero balance in a first account; and
in response to determining that the customer has the zero balance in the first account, sending marketing materials to the customer to solicit the customer to open a second account.

34. The method of claim 33, wherein the first account is a loan account.

35. The method of claim 34, wherein the second account is a loan account.

36. The method of claim 34, wherein the second account is a credit card account.

37. A system comprising:
a memory;
a communication port; and
a processor connected to said memory and said communication port, said processor being operative to:
determine that a customer has a zero balance in a first account; and
in response to determining that the customer has the zero balance in the first account, send marketing materials to the customer to solicit the customer to open a second account.

38. The system of claim 37, wherein the first account is a loan account.

39. The system of claim 38, wherein the second account is a loan account.

40. The system of claim 38, wherein the second account is a credit card account.

41. A computer program product in a computer readable medium, comprising:
first instructions for determining that a customer has a zero balance in a first account; and
second instructions for, in response to determining that the customer has the zero balance in the first account, sending marketing materials to the customer to solicit the customer to open a second account.

42. The computer program product of claim 41, wherein the first account is a loan account.

43. The computer program product of claim 42, wherein the second account is a loan account.

44. The computer program product of claim 42, wherein the second account is a credit card account.
